(19) United States
(12) Patent Application Publication
(10) Pub. No.: US 2009/0182819 A1
(43) Pub. Date: Jul. 16, 2009

(54) TECHNIQUES TO SELECTIVELY SHARE MESSAGES

(75) Inventors: Anton W. Krantz, Kirkland, WA (US); Niraj Khanchandani, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/013,473

(22) Filed: Jan. 14, 2008

(51) Int. Cl. G06F 15/16; H04M 3/533; H04L 9/32

(52) U.S. Cl. 709/206; 379/88.17; 709/202; 726/4

(57) ABSTRACT

Techniques to selectively share messages are described. An apparatus may comprise a trusted delegate server having a message sharing module. The message sharing module may be operative to selectively retrieve messages for a primary message recipient from a unified messaging server based on a message type defined by a message sharing policy. The messaging sharing module may send the messages to a secondary message recipient for the message type as defined by the message sharing policy over a packet-switched network. Other embodiments are described and claimed.

### BACKGROUND

Unified messaging is the integration of different streams of communication into a single or unified message store accessible to different devices. The different streams of communication may include electronic mail (“email”), facsimile, voice mail and so forth. The use of a unified message store provides the advantage of allowing an operator or user to access different types of messages using a single application interface, such as an email program. For example, voice mail messages may be stored as audio file attachments to an email in the user's email inbox, or converted from audio to text using a translator. The integration of different messages into a single message store, however, forms a monolithic data store of composite messages. In some cases, this makes it difficult to extract various types of messages from the monolithic data store to route to different devices. Consequently there may be a need for improved unified messaging techniques for use in a device or network.

### SUMMARY

Various embodiments may be generally directed to communications networks. Some embodiments may be particularly directed to unified messaging systems for a communications network. Further, some embodiments may relate to improved techniques to selectively share messages from a unified messaging system with multiple operators or users.

In one embodiment, for example, an apparatus may comprise a trusted delegate server having a message sharing module. The message sharing module may be operative to selectively retrieve messages for a primary message recipient from a unified messaging server based on a message type defined by a message sharing policy. The messaging sharing module may send the messages to a secondary message recipient for the message type as defined by the message sharing policy over a packet-switched network. Other embodiments are described and claimed.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates one embodiment of a communication system.

FIG. 2 illustrates one embodiment of a first message flow.

FIG. 3 illustrates one embodiment of a second message flow.

FIG. 4 illustrates one embodiment of a third message flow.

FIG. 5 illustrates one embodiment of a logic flow.

FIG. 6 illustrates one embodiment of a computing system architecture.

### DETAILED DESCRIPTION

Various embodiments are generally directed to techniques to selectively share messages across multiple recipients for a unified message system. Such embodiments may implement a trusted entity that may operate as a delegate for one or more authorized users permitted to retrieve a message of a certain message type on behalf of another user. The trusted entity and the unified messaging infrastructure may define trusted relationships based on a trusted policy, such as a message sharing policy. The trusted entity could have the characteristics of being within the trusted boundaries of the unified messaging infrastructure, and be ubiquitously available to other elements sharing the same or similar levels of trust.

Various embodiments may implement the trusted entity in the form of a trusted delegate server. The trusted delegate server may comprise or be implemented as any electronic device having processing, memory and communications capabilities sufficient to operate as a delegate, agent or proxy for a client device. Any electronic device may be suitable for modification as a trusted delegate server as long as it is ubiquitously available to the client devices and the unified messaging system infrastructure.

In one embodiment, for example, the trusted delegate server may be implemented as a Session Initiation Protocol (SIP) network element, such as a SIP proxy server. A SIP proxy server is particularly suitable for implementation as the trusted delegate server since it is ubiquitously available across a wide area network (WAN). Furthermore, a SIP proxy server is typically part of a trusted network, which may be advantageous when the client devices sharing a given type of message are part of different network domains.

The trusted delegate server implemented as a SIP proxy server may be designed to interoperate with various unified messaging system elements to selectively retrieve and route messages among multiple client devices. A first user may authorize a second user or group of users to selectively access messages of various message types from a unified messaging system on behalf of the first user. The various message types may represent, for example, various and different forms of communication techniques, channels or mechanisms. This set of permissions and access rights may be programmed by the message sharing policy. By way of example, a manager may authorize an administrative assistant to selectively access voice mail messages from a unified messaging server on behalf of the manager in the message sharing policy, thereby allowing the trusted delegate server to retrieve voice mail messages from the composite message store maintained by the unified messaging server for the manager, and send the retrieved voice mail messages to the administrative assistant.

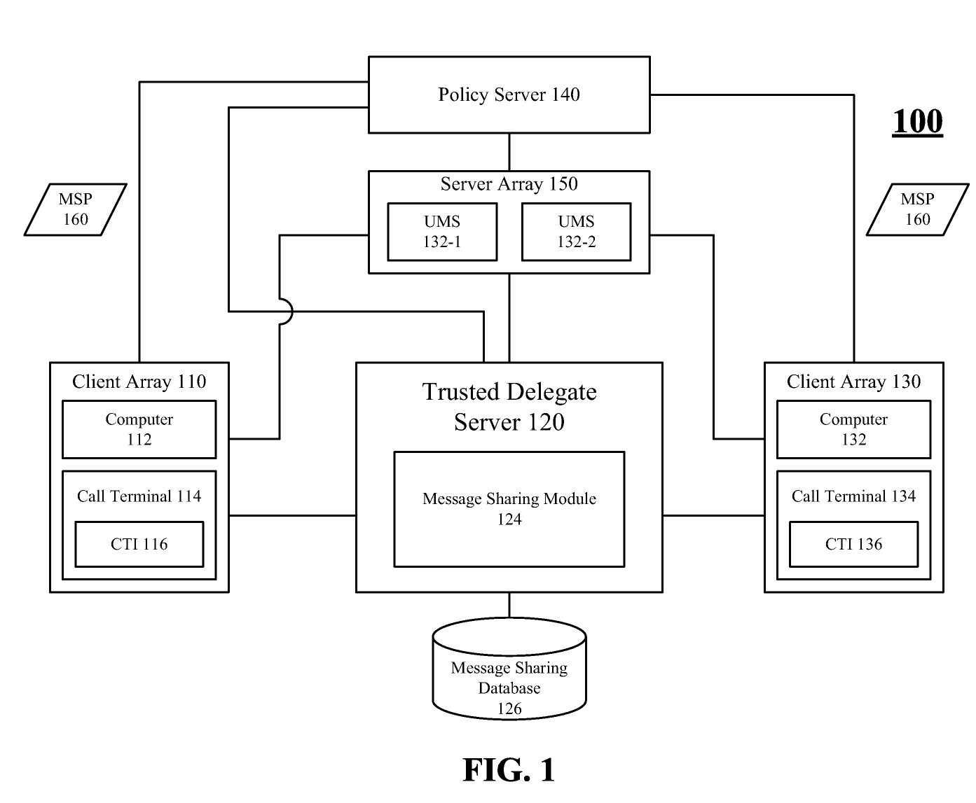

FIG. 1 illustrates one embodiment of a communications system 100. The communications system 100 may represent a general system architecture suitable for implementing various embodiments. The communications system 100 may comprise multiple elements. An element may comprise any physical or logical structure arranged to perform certain operations. Each element may be implemented as a hardware element, a software element, or any combination thereof, as desired for a given set of design parameters or performance constraints. Examples of hardware elements may include without limitation devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include without limitation any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof. Although the communications system 100 as shown in FIG. 1 has a limited number of elements in a certain topology, it may be appreciated that the communications system 100 may include more or less elements in alternate topologies as desired for a given implementation. The embodiments are not limited in this context.

In various embodiments, portions of the communications system 100 may be implemented as a packet-switched network, a circuit-switched network, or a combination of both. A packet-switched network may comprise any network capable of transporting information in discrete data units utilizing various packet-switched protocols, such as the Transport Control Protocol (TCP), User Datagram Protocol (UDP), and Internet Protocol (IP), and various VoIP protocols, to name just a few. Examples of a packet-switched network may include the public Internet and private enterprise networks. A circuit-switched network may include any network capable of transporting call information utilizing various circuit-switched protocols, such as Pulse Code Module (PCM). Examples of a circuit-switched network may include the Public Switched Telephone Network (PSTN), a private voice network, and so forth.

In the illustrated embodiment shown in FIG. 1, the communications system 100 may implement various elements and infrastructure for a unified messaging system. For example, the communications system 100 may include a server array 150 having multiple unified messaging servers 132-1-n. The unified messaging servers 132-1-n are designed to integrate different streams of communications messages into a single or unified message store accessible to different client devices, such as those comprising part of the client arrays 110, 130. The different streams of communications messages may include a host of different message types, including without limitation a voice mail message type, an email message type, an instant message (IM) type, a facsimile message type, a video message type, a multimedia message type, a chat message type, a group chat message type, a short messaging service (SMS) message type, a multimedia messaging service (MMS) message type, and so forth. The embodiments are not limited in this context.

The unified messaging servers 132-1-n within the server array 150 may service different domains within a network. In one embodiment, for example, the unified message server 132-1 may be logically or physically implemented within a first domain with the computer 112 of the client array 110, the unified message server 132-2 may be logically or physically implemented within a second domain with the computer 132 of the client array 130, and so forth. Furthermore, in some cases the domains may comprise trusted domains, thereby allowing the various elements within a given domain to communicate with each other using a lower level of security relative to the elements outside of the given domain. It is worthy to note that although the unified messaging servers 132-1-n are shown as part of the server array 150 for clarity, it may be appreciated that the unified messaging servers 132-1-n may be implemented in different server arrays or as independent servers.

The communications system 100 may further include a policy server 140. The policy server 140 may comprise or be implemented as any electronic device capable of managing or administering permissions or access rights to specific users or groups of users for the communications system 100. The policy server 140 may generally implement policy rules that allow users to view or make changes to various system programs or application programs, particularly with respect to the contents of the file system for such programs.

In one embodiment, for example, the policy server 140 may be implemented as part of an Active Directory (AD) server, as made by MICROSOFT® Corporation, Redmond, Wash. An AD server is an implementation of Lightweight Directory Access Protocol (LDAP) directory services for use primarily in MICROSOFT WINDOWS® operating environments. An AD server provides central authentication and authorization services for Windows based computers. An AD server also allows administrators to assign policies, deploy software, and apply critical updates to an organization. The AD server typically stores information and settings in a central database. It may be appreciated that the policy server 140 is not limited to this example.

The communications system 100 may include one or more client devices. The client devices may comprise or be implemented as any application, system or electronic device having communications capabilities arranged to access a remote service on another computer system such as a server through a network. In one embodiment, for example, the communications system 100 may include client arrays 110, 130. The client arrays 110, 130 may represent an exemplary arrangement of client devices typically owned by an operator or user at a home or office. The client arrays 110, 130 may each comprise a number of separate or integrated client devices. As shown in FIG. 1 by way of example, the client array 110 may include a computer 112 and a call terminal 114, and the client array 130 may include a computer 132 and a call terminal 134.

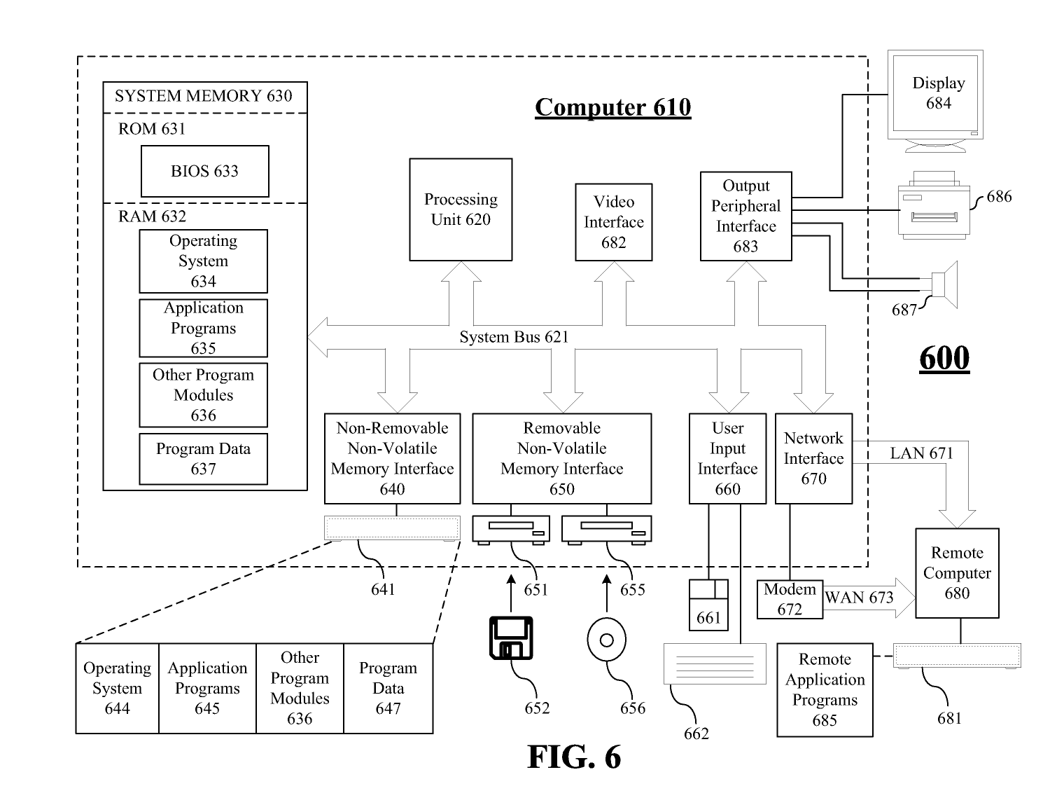

The computers 112, 132 of the client array 110, 130 may represent personal computers (PC) having a computing system architecture as described in more detail with reference to FIG. 6. The computers 112, 132 may include, among other programs, an application program suitable for sending and retrieving messages from a unified messaging server, such as one or more of the unified messaging servers 132-1-n of the server array 150. For example, the application program may comprise an email application program capable of creating, managing and communicating various messages of different message types as previously described with reference to the unified messaging servers 132-1-n. The email application program may store voice mail messages as audio file attachments to an email in the user's email inbox, or as an email message with text converted from the audio file using a translator.

The call terminals 114, 134 may comprise or be implemented as any electronic device having call capabilities. Examples for the call terminals 114, 134 may include without limitation a phone, a telephone, an analog telephone, a digital telephone, a VoIP telephone, an Internet telephone, an Internet Protocol (IP) telephone, a cellular telephone, a smart phone, a combination cellular telephone and personal digital assistant (PDA), a soft telephone (e.g., a processing device executing call software), and so forth. In one embodiment, for example, the call terminals 114, 134 may each comprise a VoIP device such as a VoIP telephone. The embodiments, however, are not limited to this example.

The call terminals 114, 134 may also include respective call terminal interfaces 116, 136. The call terminal interfaces 116, 136 may comprise user interfaces or graphic user interfaces having views designed to allow the operators of the call terminals 114, 134 to implement various message sharing operations, including creating message sharing policies, retrieving messages by one operator on behalf of another operator, displaying messages for both operators in separate views, and so forth.

The use of a unified message store provides the client arrays 110, 130 the advantage of allowing respective operators to access different types of messages using a single application interface, such as an email program. While convenient when operating the computers 112, 132, the integration of different messages into a single message store forms a monolithic data store of composite messages. This potentially makes it difficult to extract various types of messages from the monolithic data store to route to different devices, such as the call terminals 114, 134. This may be particularly burdensome when an operator of one call terminal desires to allow one or more operators of different call terminals to access messages. Such a message sharing arrangement is common in a business environment, such as when an administrative assistant checks messages on behalf of a manager. Often the single monolithic message store makes it difficult to selectively retrieve messages of a given message type, such as only voice mail messages, without granting access to all the message types within the message store.

To solve these and other problems, various embodiments implement a trusted entity that may operate as a delegate for authorized users permitted to retrieve a message on behalf of another user. The trusted entity and the unified messaging infrastructure may define trusted relationships based on a trusted policy, such as a message sharing policy. The trusted entity could have the characteristics of being within the trusted boundaries of the unified messaging infrastructure, and be ubiquitously available to other elements sharing the same or similar levels of trust. The trusted entity in this case is relied on by the server and the client to perform appropriate communication filtering, and deliver only authorized communications to the clients by the trusted entity based on a well-defined policy.

In various embodiments, the communications system 100 may include a trusted delegate server 120. The trusted delegate server 120 may comprise or be implemented as any electronic device having processing, memory and communications capabilities sufficient to operate as a delegate, agent or proxy for the client arrays 110, 130. Examples for the trusted delegate server 120 may be implemented on any type of processing device, such as a computer, a personal computer, a laptop computer, a server, a work station, a media server, a network appliance, consumer electronics, and so forth. Any processing device may be suitable for modification as a trusted delegate server as long as it is ubiquitously available to the client arrays 110, 130 (e.g., the call terminals 114, 134) and the unified messaging system infrastructure.

In one embodiment, the trusted delegate server 120 may be implemented as a network server configured to communicate control and media information over a packet-switched network. For example, the trusted delegate server 120 may be implemented as a network server arranged to establish a VoIP telephone call or conference call using a VoIP signaling protocol as defined and promulgated by the Internet Engineering Task Force (IETF) standards organization.

In one embodiment, for example, the trusted delegate server 120 may be implemented as a Session Initiation Protocol (SIP) network element, such as a SIP proxy server as defined by the IETF series RFC 3261, 3265, 3853, 4320 and progeny, revisions and variants. In general, the SIP signaling protocol is an application-layer control and/or signaling protocol for creating, modifying, and terminating sessions with one or more participants. These sessions include IP telephone calls, multimedia distribution, and multimedia conferences. A SIP proxy server is a SIP network element specifically designed to route requests to a user's current location, authenticate and authorize users for services, implement provider call-routing policies, provide features to users, and so forth. When the trusted delegate server 120 is implemented as a SIP network element, the call terminals 114, 134 may be implemented as corresponding SIP network elements as well, such as SIP user agents, for example. Other suitable network elements for the trusted delegate server 120 may include network devices implementing various network protocols, such as an Extensible Messaging and Presence Protocol (XMPP) server, a web server using a Simple Object Access Protocol (SOAP), an International Telecommunication Union Telecommunication Standardization Sector (ITU-T) H.323 server, a Media Gateway Control Protocol (MGCP) server, and so forth. The embodiments are not limited in this context.

A SIP proxy server is particularly suitable for implementation as the trusted delegate server 120 since it is ubiquitously available across a wide area network (WAN). Furthermore, a SIP proxy server is typically part of a trusted network, such as the different network domains for the client arrays 110, 130. Although some embodiments describe the trusted delegate server 120 implemented as part of a SIP proxy server by way of example and not limitation, the embodiments are not necessarily limited to any particular SIP network element, or any other network elements using different VoIP signaling and transport protocols. It may be appreciated that the trusted delegate server 120 may be implemented as part of any network device separate from the client arrays 110, 130 (e.g., the call terminals 114, 134) and that is ubiquitously available to the client device and the unified messaging system infrastructure for a given network environment.

As shown in FIG. 1, one embodiment of the trusted delegate server 120 may include a SIP proxy server having, among other elements, a message sharing module 124. The message sharing module 124 may comprise a physical or logical device arranged to interoperate with the other elements of the communications system 100 to manage message sharing operations between various client devices, such as those comprising part of the client arrays 110, 130.

In one embodiment, the message sharing module 124 may be generally operative to selectively retrieve messages for a primary message recipient from a unified messaging server based on a message type defined by a message sharing policy. The messaging sharing module 124 may send the messages to a secondary message recipient for the message type as defined by the message sharing policy. The message sharing module 124 may send the messages, for example, over a packet-switched network using various packet-based IETF protocols (e.g., TCP, IP, UDP, RTP, SIP, and so forth).

By way of example, assume the primary message recipient is a manager using the client array 110, and the secondary message recipient is an administrative assistant using the client array 130. Further assume the unified messaging servers 132-1, 132-2 provide unified messaging services for the respective computers 112, 132 of the respective client arrays 110, 130. To provide such unified messaging services, the computer 112 and unified messaging server 132-1 are within a first trusted domain, while the computer 132 and the unified messaging server 132-2 are within a second trusted domain. With respect to the call terminals 114, 134, assume the trusted delegate server 120 comprises a SIP server providing VoIP services for the call terminals 114, 134. Since the SIP server provides VoIP services to both client arrays 110, 130, the trusted delegate server 120 is a trusted entity for both the first domain and the second domain. For this and other reasons, the SIP server is a suitable candidate for implementation as the trusted delegate server 120.

In one use scenario, assume a manager would like to the administrative assistant to have access to a selectively set of messages for the manager. Since the client arrays 110, 130 are within different domains, however, the client array 130 needs to have some limited access to the first domain. The permissions and access rights for the client array 130 may be defined as some form of a trust policy. In the context of sharing messages between entities of different domains, the trust policy may be referred to herein as a message sharing policy 160. The specific message sharing policy 160 for a given implementation may be defined by any number of entities, including operators for the client arrays 110, 130. This may be accomplished via the call terminal interfaces 116, 136 of the respective call terminals 114, 134, or similar user interfaces implemented for the respective computers 112, 132. The message sharing policy 160 may be managed or administered using one or more network elements of the communications system 100, such as the policy server 140. One suitable candidate for the policy server 140 may include a centralized AD server, as previously described, although the embodiments are not limited in this context. For example, the message sharing policy 160 may be managed in a distributed manner, with a portion of the management operations delegated to the trusted delegate server 120.

The message sharing module 124 may be operative to selectively retrieve messages for the manager from a unified messaging server 132-1 based on a message type defined by a message sharing policy 160. For example, assume a manager authorizes the administrative assistant to have access to a selectively set of messages for the manager, such as only voice mail messages. The manager may use the user interface or graphics user interface (GUI) of the call terminal interface 116 to access the policy server 140 and program the appropriate parameters allowing the administrative assistant limited access to the composite message store of the unified messaging server 132-1 for the manager to selectively retrieve only voice mail messages from the composite message store. The policy server 140 may store the message sharing policy 160, and administer the message sharing policy across the affected elements of the communications system 100, including the server array 150 and/or the trusted delegate server 120. The message sharing module 124 may create a message sharing record for the primary message recipient and/or secondary message recipient for a given message type in accordance with the message sharing policy 160, and store the message sharing record in the message sharing database 126.

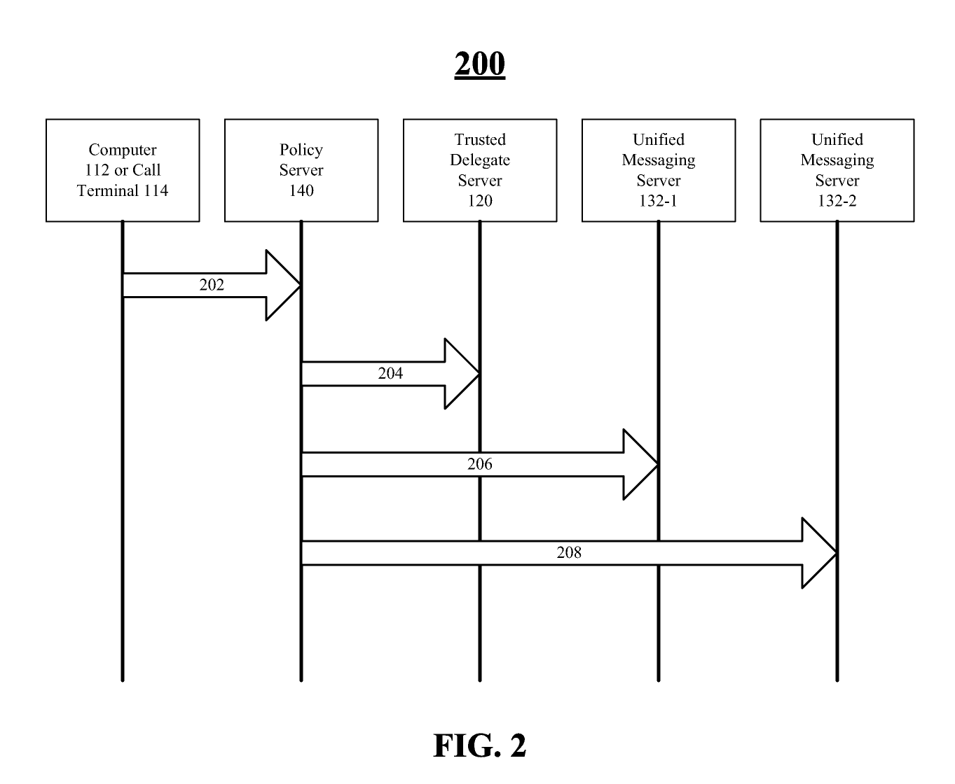

Once the message sharing policy 160 has been implemented for the unified messaging infrastructure, the message sharing module 124 of the trusted delegate server 120 may then begin to share messages of a given message type between the primary message recipient and the secondary message recipient. The message sharing module 124 may engage in various message sharing operations, including retrieving select messages for the primary message recipient from the unified messaging server 132-1, and sending the retrieved messages to the secondary message recipient. For example, an administrative assistant may then gain access to certain messages (e.g., voice mail messages) for the manager even though the administrative assistant is in a separate domain, and without having access to any other message types (e.g., email messages) provided by the composite message store for the manager as maintained by the unified messaging server 132-1. Operations for trusted delegate server 120 in general, and the message sharing module 124 in particular, may be described in more detail with reference to the message flows shown in FIGS. 2-5.

FIG. 2 illustrates one embodiment of a message flow 200. The message flow 200 illustrates one example of a message flow for the establishing the message sharing policy 160 within the unified messaging infrastructure of the communications system 100. Assume the operator and primary message recipient (e.g., the manager) of the client array 110 desires to establish a message sharing policy to allow the operator and secondary message recipient (e.g., the administrative assistant) of the client array 130 to access voice mail messages for the primary message recipient. The manager may access computer 112 and/or the call terminal 114 (via the call terminal interface 116) to grant message sharing privileges to the administrative assistant thereby creating or modifying the message sharing policy 160 implemented by the policy server 140 as indicated by the arrow 202. The policy server 140 may send the updates to the various network elements affected by the message sharing policy 160, such as the trusted delegate server 120, the unified messaging server 132-1, and/or the unified messaging server 132-2, as indicated by the respective arrows 204, 206, 208.

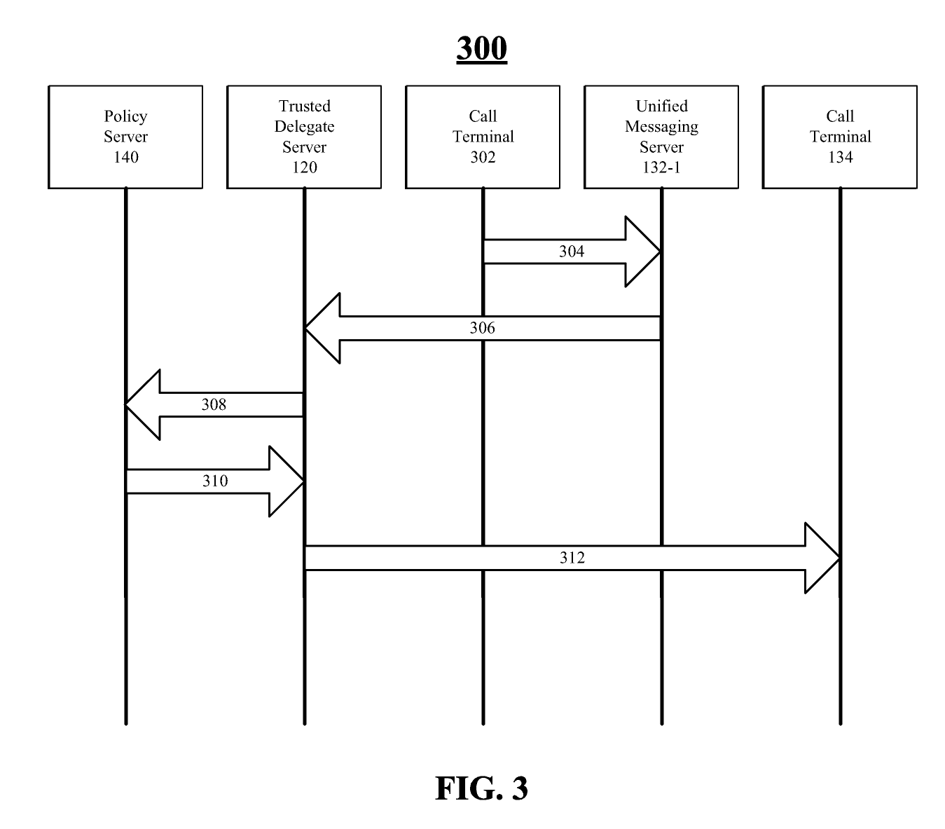

FIG. 3 illustrates one embodiment of a message flow 300. The message flow 300 illustrates one example of a message flow for the trusted delegate server 120 to retrieve messages for the primary message recipient from the unified messaging server 132-1 by the trusted delegate server 120 based on the message type defined by the message sharing policy 160. Assume an operator for a call terminal 302 attempts to call the call terminal 114 of the client array 110, and the manager does not answer. The call terminal 114 may record a voice mail message for the manager, or alternatively, may route the call request to the unified message server 132-1 to record the voice mail message. In either case, a new voice mail message may be stored for the manager by the unified messaging server 132-1 as indicated by the arrow 304. The unified messaging server 132-1 may send notification of the new voice mail message to the trusted delegate server 132-1 as indicated by the arrow 306. The message sharing module 124 may receive notification for a new message with the voice mail message type from the unified messaging server 132-1. The message sharing module 124 may send a permissions request for the authorized message recipients for the voice mail message type to the policy server 140 as indicated by the arrow 208. The authorized message recipients may comprise a single user or group of users. For example, the authorized message recipients may include multiple authorized message recipients for a message type, such as the primary message recipient, a secondary message recipient, a third message recipient, and so forth. The policy server 140 may check the message sharing policy 160 to retrieve a list of authorized message recipients for the voice mail message type. The policy server 140 may generate and send a permissions response with the authorized message recipients, including the secondary message recipient, for the message type to the trusted delegate server 132-1 as indicated by the arrow 310. The trusted delegate server 120 may receive the permissions response with the list of authorized message recipients, including the secondary message recipient, and send a message waiting indicator (MWI) to the call terminal 134 (or computer 132) of the client array 130 for the secondary message recipient as indicated by the arrow 312. In this manner, the administrative assistant as the secondary message recipient may be notified that a new message for the manager has been received by the unified messaging infrastructure. In addition to the secondary message recipient, the trusted delegate server 120 may also send a MWI to the call terminal 114 of the primary message recipient as well, thereby providing an alternate or additional indicator to the computer 112 that a new voice mail message is waiting for the manager.

It is worthy to note that the operations of querying the policy server 140 to retrieve the list of authorized message recipients as indicated by the arrows 308, 310 may in some cases be reduced or eliminated. For example, the message sharing module 124 may store the message sharing policy 160 as a message sharing record in the message sharing database 126. In this case, the message sharing policy 160 may retrieve the list of authorized message recipients directly from the message sharing database 126. In another example, the various message recipients may have user attributes stored by the message sharing database 126, and the message sharing module 124 may determine the secondary message recipient for the message type based on the user attributes associated with the primary message recipient or the secondary message recipient.

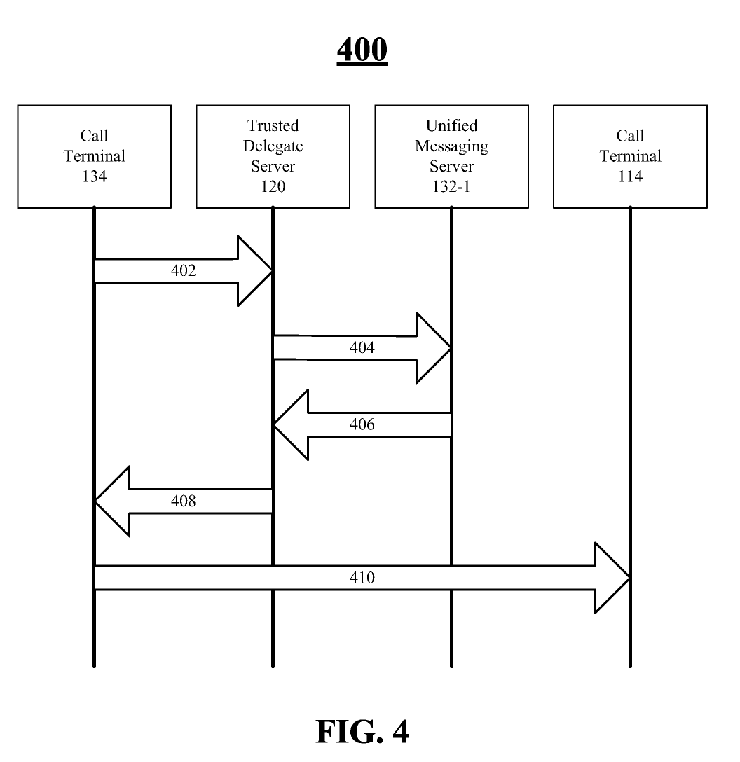

FIG. 4 illustrates one embodiment of a message flow 400. The message flow 400 illustrates one example of a message flow for the trusted delegate server 120 to send the messages to the secondary message recipient for the message type as defined by the message sharing policy 160 over a packet-switched network. As shown in FIG. 4, the call terminal 134 may receive the MWI from the trusted delegate server 120. The administrative assistant may decide to access the new message in response to the MWI. The call terminal 134 may send a message retrieval request to the trusted delegate server 120 as indicated by the arrow 402. The trusted delegate server 120 may receive the message retrieval request from the secondary message recipient, and retrieve the new voice mail message for the primary message recipient from the unified messaging server 132-1 in response to the message retrieval request as indicated by the arrows 404, 406. The trusted delegate server 120 may send the retrieved voice mail message to the call terminal 134 as indicated by the arrow 408. Optionally, the administrative assistant may use the call terminal interface 116 of the call terminal 134 to update the call terminal 114 for the manager to indicate that the administrative assistant has accessed the new voice mail message as indicated by the arrow 410.

Operations for the communications system 100 may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more elements of the communications system 100 or alternative elements as desired for a given set of design and performance constraints. Other anti-spam activities may be interspersed into these operations.

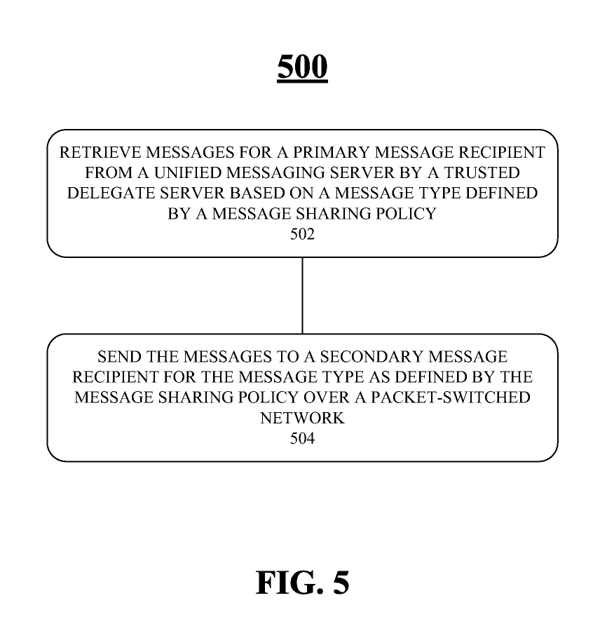

FIG. 5 illustrates a logic flow 500. The logic flow 500 may be representative of the operations executed by one or more embodiments described herein, such as one or more operations performed by the trusted delegate server 120, for example. As shown in FIG. 5, the logic flow 500 may retrieve messages for a primary message recipient from a unified messaging server by a trusted delegate server based on a message type defined by a message sharing policy at block 502. The logic flow 500 may send the messages to a secondary message recipient for the message type as defined by the message sharing policy over a packet-switched network. The embodiments are not limited in this context.

In one embodiment, the logic flow 500 may retrieve messages for a primary message recipient from a unified messaging server by a trusted delegate server based on a message type defined by a message sharing policy at block 502. For example, the trusted delegate server 120 may retrieve messages for the primary message recipient of the client array 110 from the unified messaging server 132-1 based on a message type defined by the message sharing policy 160. The trusted delegate server 120 may retrieve the messages for the primary message recipient in preparation to send the message to other authorized message recipients with permission and access rights to the messages.

In one embodiment, the logic flow 500 may send the messages to a secondary message recipient for the message type as defined by the message sharing policy over a packet-switched network. For example, the trusted delegate server 120 may send the retrieved messages to the secondary message recipient of the client array 130 for the message type defined by the message sharing policy 160. The trusted delegate server 120 may send a MWI, the message, or both to the call terminal 134 of the client array 130. The call terminal interface 136 may display a GUI view of the message with other messages for the secondary message recipient (e.g., their own email messages, text messages, etc.), or in a separate GUI view for the retrieved message. The trusted delegate server 120 may send the message over a packet-switched network, such as the Internet, a private network, a corporate network, a secure network, a trusted network, and so forth.

FIG. 6 illustrates a block diagram of a computing system architecture 600 suitable for implementing various embodiments. It may be appreciated that the computing system architecture 600 is only one example of a suitable computing environment and is not intended to suggest any limitation as to the scope of use or functionality of the embodiments. Neither should the computing system architecture 600 be interpreted as having any dependency or requirement relating to any one or combination of components illustrated in the exemplary computing system architecture 600.

Various embodiments may be described in the general context of computer-executable instructions, such as program modules, being executed by a computer. Generally, program modules include any software element arranged to perform particular operations or implement particular abstract data types. Some embodiments may also be practiced in distributed computing environments where operations are performed by one or more remote processing devices that are linked through a communications network. In a distributed computing environment, program modules may be located in both local and remote computer storage media including memory storage devices.

As shown in FIG. 6, the computing system architecture 600 includes a general purpose computing device such as a computer 610. The computer 610 may include various components typically found in a computer or processing system. Some illustrative components of computer 610 may include, but are not limited to, a processing unit 620 and a memory unit 630.

In one embodiment, for example, the computer 610 may include one or more processing units 620. A processing unit 620 may comprise any hardware element or software element arranged to process information or data. Some examples of the processing unit 620 may include, without limitation, a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processing unit 620 may be implemented as a general purpose processor. Alternatively, the processing unit 620 may be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), an application specific integrated circuit (ASIC), and so forth. The embodiments are not limited in this context.

In one embodiment, for example, the computer 610 may include one or more memory units 630 coupled to the processing unit 620. A memory unit 630 may be any hardware element arranged to store information or data. Some examples of memory units may include, without limitation, random-access memory (RAM), dynamic RAM (DRAM), Double-Data-Rate DRAM (DDRAM), synchronous DRAM (SDRAM), static RAM (SRAM), read-only memory (ROM), programmable ROM (PROM), erasable programmable ROM (EPROM), EEPROM, Compact Disk ROM (CD-ROM), Compact Disk Recordable (CD-R), Compact Disk Rewriteable (CD-RW), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk (e.g., floppy disk, hard drive, optical disk, magnetic disk, magneto-optical disk), or card (e.g., magnetic card, optical card), tape, cassette, or any other medium which can be used to store the desired information and which can accessed by computer 610. The embodiments are not limited in this context.

In one embodiment, for example, the computer 610 may include a system bus 621 that couples various system components including the memory unit 630 to the processing unit 620. A system bus 621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and so forth. The embodiments are not limited in this context.

In various embodiments, the computer 610 may include various types of storage media. Storage media may represent any storage media capable of storing data or information, such as volatile or non-volatile memory, removable or non-removable memory, erasable or non-erasable memory, writeable or re-writeable memory, and so forth. Storage media may include two general types, including computer readable media or communication media. Computer readable media may include storage media adapted for reading and writing to a computing system, such as the computing system architecture 600. Examples of computer readable media for computing system architecture 600 may include, but are not limited to, volatile and/or nonvolatile memory such as ROM 631 and RAM 632. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF) spectrum, infrared and other wireless media. Combinations of the any of the above should also be included within the scope of computer readable media.

In various embodiments, the memory unit 630 includes computer storage media in the form of volatile and/or nonvolatile memory such as ROM 631 and RAM 632. A basic input/output system 633 (BIOS), containing the basic routines that help to transfer information between elements within computer 610, such as during start-up, is typically stored in ROM 631. RAM 632 typically contains data and/or program modules that are immediately accessible to and/or presently being operated on by processing unit 620. By way of example, and not limitation, FIG. 6 illustrates operating system 634, application programs 635, other program modules 636, and program data 637.

The computer 610 may also include other removable/non-removable, volatile/nonvolatile computer storage media. By way of example only, FIG. 6 illustrates a hard disk drive 641 that reads from or writes to non-removable, nonvolatile magnetic media, a magnetic disk drive 651 that reads from or writes to a removable, nonvolatile magnetic disk 652, and an optical disk drive 655 that reads from or writes to a removable, nonvolatile optical disk 656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 641 is typically connected to the system bus 621 through a non-removable memory interface such as interface 640, and magnetic disk drive 651 and optical disk drive 655 are typically connected to the system bus 621 by a removable memory interface, such as interface 650.

The drives and their associated computer storage media discussed above and illustrated in FIG. 6, provide storage of computer readable instructions, data structures, program modules and other data for the computer 610. In FIG. 6, for example, hard disk drive 641 is illustrated as storing operating system 644, application programs 645, other program modules 646, and program data 647. Note that these components can either be the same as or different from operating system 634, application programs 635, other program modules 636, and program data 637. Operating system 644, application programs 645, other program modules 646, and program data 647 are given different numbers here to illustrate that, at a minimum, they are different copies. A user may enter commands and information into the computer 610 through input devices such as a keyboard 662 and pointing device 661, commonly referred to as a mouse, trackball or touch pad. Other input devices (not shown) may include a microphone, joystick, game pad, satellite dish, scanner, or the like. These and other input devices are often connected to the processing unit 620 through a user input interface 660 that is coupled to the system bus, but may be connected by other interface and bus structures, such as a parallel port, game port or a universal serial bus (USB). A monitor 684 or other type of display device is also connected to the system bus 621 via an interface, such as a video processing unit or interface 682. In addition to the monitor 684, computers may also include other peripheral output devices such as speakers 687 and printer 686, which may be connected through an output peripheral interface 683.

The computer 610 may operate in a networked environment using logical connections to one or more remote computers, such as a remote computer 680. The remote computer 680 may be a personal computer (PC), a server, a router, a network PC, a peer device or other common network node, and typically includes many or all of the elements described above relative to the computer 610, although only a memory storage device 681 has been illustrated in FIG. 6 for clarity. The logical connections depicted in FIG. 6 include a local area network (LAN) 671 and a wide area network (WAN) 673, but may also include other networks. Such networking environments are commonplace in offices, enterprise-wide computer networks, intranets and the Internet.

When used in a LAN networking environment, the computer 610 is connected to the LAN 671 through an adapter or network interface 670. When used in a WAN networking environment, the computer 610 typically includes a modem 672 or other technique suitable for establishing communications over the WAN 673, such as the Internet. The modem 672, which may be internal or external, may be connected to the system bus 621 via the network interface 670, or other appropriate mechanism. In a networked environment, program modules depicted relative to the computer 610, or portions thereof, may be stored in the remote memory storage device. By way of example, and not limitation, FIG. 6 illustrates remote application programs 685 as residing on memory device 681. It will be appreciated that the network connections shown are exemplary and other techniques for establishing a communications link between the computers may be used. Further, the network connections may be implemented as wired or wireless connections. In the latter case, the computing system architecture 600 may be modified with various elements suitable for wireless communications, such as one or more antennas, transmitters, receivers, transceivers, radios, amplifiers, filters, communications interfaces, and other wireless elements. A wireless communication system communicates information or data over a wireless communication medium, such as one or more portions or bands of RF spectrum, for example. The embodiments are not limited in this context.

Some or all of the computing system architecture 600 may be implemented as a part, component or sub-system of an electronic device. Examples of electronic devices may include, without limitation, a processing system, computer, server, work station, appliance, terminal, personal computer, laptop, ultra-laptop, handheld computer, minicomputer, mainframe computer, distributed computing system, multiprocessor systems, processor-based systems, consumer electronics, programmable consumer electronics, personal digital assistant, television, digital television, set top box, telephone, mobile telephone, cellular telephone, handset, wireless access point, base station, subscriber station, mobile subscriber center, radio network controller, router, hub, gateway, bridge, switch, machine, or combination thereof. The embodiments are not limited in this context.

In some cases, various embodiments may be implemented as an article of manufacture. The article of manufacture may include a storage medium arranged to store logic and/or data for performing various operations of one or more embodiments. Examples of storage media may include, without limitation, those examples as previously described. In various embodiments, for example, the article of manufacture may comprise a magnetic disk, optical disk, flash memory or firmware containing computer program instructions suitable for execution by a general purpose processor or application specific processor. The embodiments, however, are not limited in this context.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
retrieving messages for a primary message recipient from a unified messaging server by a trusted delegate server based on a message type defined by a message sharing policy; and
sending the messages to a secondary message recipient for the message type as defined by the message sharing policy over a packet-switched network.

2. The method of claim 1, comprising retrieving voice mail messages for the primary message recipient from the unified messaging server.

3. The method of claim 1, comprising receiving notification for a new message with the message type from the unified messaging server.

4. The method of claim 1, comprising retrieving messages for the primary message recipient from the unified messaging server by a session initiation protocol server as the trusted delegate server.

5. The method of claim 1, comprising sending a permissions request for the secondary message recipient for the message type to a policy server.

6. The method of claim 1, comprising receiving a permissions response with the secondary message recipient for the message type from a policy server.

7. The method of claim 1, comprising determining the secondary message recipient for the message type based on user attributes associated with the primary message recipient or the secondary message recipient.

8. The method of claim 1, comprising sending a message waiting indicator to the primary message recipient or the secondary message recipient.

9. The method of claim 1, comprising receiving a message retrieval request from the secondary message recipient.

10. The method of claim 1, comprising retrieving the messages for the primary message recipient from the unified messaging server in response to a message retrieval request.

11. An article comprising a storage medium containing instructions that if executed enable a system to:
retrieve a select set of messages from among a group of messages for a primary message recipient from a unified messaging server by a trusted delegate server based on a message type defined by a message sharing policy; and
send the select set of messages to a secondary message recipient for the message type as defined by the message sharing policy over a packet-switched network.

12. The article of claim 11, comprising instructions that if executed enable the system to retrieve a select set of voice mail messages from among the group of messages for the primary message recipient from the unified messaging server.

13. The article of claim 11, comprising instructions that if executed enable the system to:
send a permissions request for the secondary message recipient for the message type to a policy server; and
receive a permissions response with the secondary message recipient for the message type from the policy server.

14. The article of claim 11, comprising instructions that if executed enable the system to send a message waiting indicator to the primary message recipient or the secondary message recipient.

15. The article of claim 11, comprising instructions that if executed enable the system to:
receive a message retrieval request from the secondary message recipient; and
retrieve the messages for the primary message recipient from the unified messaging server in response to the message retrieval request.

16. An apparatus comprising a trusted delegate server having a message sharing module operative to selectively retrieve messages for a primary message recipient from a unified messaging server based on a message type defined by a message sharing policy, and send the messages to a secondary message recipient for the message type as defined by the message sharing policy over a packet-switched network.

17. The apparatus of claim 16, the trusted delegate server comprising a session initiation protocol server.

18. The apparatus of claim 16, comprising a message sharing database to couple to the message sharing module, the message sharing database to store a message sharing record with the secondary message recipient for the message type.

19. The apparatus of claim 16, the message type comprising a voice mail message type, an electronic mail message type, an instant message type, a facsimile message type, a video message type, a multimedia message type, a chat message type, a group chat message type, a short messaging service message type, or a multimedia messaging service message type.

20. The apparatus of claim 16, the primary message recipient and the secondary message recipient authorized to access unified messaging services from different domains.
